(19) United States
(12) Patent Application Publication
(10) Pub. No.: US 2002/0180881 A1
(43) Pub. Date: Dec. 5, 2002

(54) Image pickup apparatus

(76) Inventors: Keito Kondoh, Hitachinaka (JP); Takashi Takahashi, Hitachinaka (JP); Shigehisa Rokuta, Hitachinaka (JP); Mitsunori Kobayashi, Hitachinaka (JP)

Correspondence Address: MCDERMOTT, WILL & EMERY, 600 13th Street, N. W., Washington, DC, 20005-3096, US

(21) Appl. No.: 09/943,419

(22) Filed: Aug. 31, 2001

(30) Foreign Application Priority Data
Apr. 26, 2001 (JP) 2001-128622

(51) Int. Cl. H04N 5/232; G03B 13/00

(52) U.S. Cl. 348/345

(57) ABSTRACT

Autofocus control for a subject in various luminance areas when a plurality of screens obtained by image picking-up the subject on a plurality of exposure conditions are synthesized to generate a wide dynamic range image. A focal voltage selector is provided for selectively outputting one, as a focal voltage to be referred to by an autofocus controller, out of focal voltages detected from a plurality of images different in exposure condition. Thus, autofocus control can be applied to various images of the subject picked up in appropriate signal levels on different exposure conditions. Further, a circuit for normalizing the focal voltages is provided. Thus, the influence of variation in exposure condition on the focal voltages is eliminated so that autofocus control can be carried out independently of exposure conditions.

### BACKGROUND OF THE INVENTION

The present invention relates to an image pickup apparatus having a lens group including lenses movable in the optical axis direction for focusing, and an image pickup device disposed at the rear of the lens group, whereby images which are obtained by image picking-up one and the same subject on different exposure conditions and which correspond to a plurality of screens are outputted from the image pickup device, and the images are synthesized to obtain a synthesized image with a wide dynamic range. Particularly, the present invention relates to an automatic focusing (autofocus) control system in such an image pickup apparatus in which the lens group is driven to adjust the focal point in accordance with the detected levels of high-frequency components contained in the images obtained from the image pickup device.

Generally, an image pickup apparatus such as a video camera or a digital camera uses a solid-state image pickup device such as a CCD image pickup device. However, there is a problem that the dynamic range of the solid-state image pickup device is extremely narrower than that of silver haloid photographic film.

In order to solve this problem, JP-A-2000-228747 or the like proposes an image pickup apparatus in which images that are obtained by image picking-up one and the same subject on different exposure conditions and that correspond to a plurality of screens are read out and synthesized to obtain an image that is magnified in its dynamic range and that corresponds to one screen.

That is, an image pickup apparatus is proposed such that first and second images obtained by image picking-up one and the same subject with the exposure increased and decreased respectively are acquired from a single image pickup device. Signals in areas of the second image corresponding to areas of the first image which have brightness not less than a predetermined level are substituted for the signals in the corresponding areas of the first image so as to obtain an image with a wide dynamic range.

On the other hand, most of the image pickup apparatuses such as video cameras or digital cameras, having a lens group movable in the optical axis direction for focusing have an autofocus function, and there is a great demand in such image pickup apparatuses from users. As for image pickup apparatuses having means for obtaining a wide dynamic range image, there is also a great demand in such image pickup apparatuses having an autofocus function from the users.

JP-A-63-181571, JP-A-63-125910, or the like has disclosed a method for controlling autofocus. That is, in an image pickup apparatus having a lens group which is movable in the optical axis direction to adjust a focal point, and an image pickup device which is disposed at the rear of the lens group, in the order of an increasing distance from a subject, there is proposed a method in which a high-frequency component contained in an image of the subject formed on a sensor plane of the image pickup device through the lens group is detected, and the lens group is driven by drive means in accordance with an offset from the focal point obtained from the level of the detected high-frequency component (hereinafter, referred to as “focal voltage”), so as to automatically adjust the focal point.

However, there is no description about an autofocus control method in an image pickup apparatus having means for obtaining a wide dynamic range image as described above.

### SUMMARY OF THE INVENTION

In an image pickup apparatus which has means for synthesizing images different in exposure condition to thereby obtain an image with a wide dynamic range as disclosed in JP-A-2000-228747, and which carries out autofocus in accordance with a focal voltage detected from the image obtained from an image pickup device as disclosed in JP-A-63-181571, when the image pickup apparatus operates in a wide dynamic range mode with a large difference in luminance in the screen, images corresponding to a plurality of screens obtained from the image pickup device have areas where the signal level is appropriate to the images and areas where the signal level is inappropriate to the images, that is, the signal level is saturated or the signal level is low to produce a black portion or spot.

At this time, when autofocus is carried out on the basis of only a focal voltage obtained from an image on a desired exposure condition a, out of the images corresponding to the plurality of screens, a focal voltage having a level which is large enough to detect an offset from a focal point can be detected from the area where the signal level is appropriate in the image on the exposure condition a. However, a focal voltage having a level which is large enough to detect an offset from a focal point cannot be detected from the area where the signal level is inappropriate. Therefore, focusing can be done on a subject in the area where the signal level is appropriate in the image in the exposure condition a, but focusing cannot be done on the subject in the other area.

For example, FIG. 1 shows examples of typical images obtained by image picking-up one and the same subject on different exposure conditions. As shown in FIG. 1, assume that when a person B in the bright outdoors was picked up through a door from a dark room, there were obtained a first image Ia picked up on an exposure condition a where a person A in the room took an appropriate signal level, and a second image Ib picked up on an exposure condition b where the person B in the outdoors took an appropriate signal level.

In this case, the person A in the first image Ia is picked up in an appropriate signal level, but the person B located at the center is picked up as a white portion or spot, inappropriate signal level.

Accordingly, when focusing is carried out in accordance with only a focal voltage obtained from the image Ia, a focal voltage sufficient for the person B cannot be obtained. Thus, only the person A in the room is brought into focus, but the person B is not brought into focus.

In addition, a focal voltage detection area is generally limited as shown in FIG. 1, in order to stop down the lens group for making a subject brought into focus. In this case, there is a problem that a sufficient focal voltage cannot be obtained from a focal voltage detection area in the image Ia so that a stable focusing operation cannot be carried out.

An object of the present invention is to provide an image pickup apparatus in which a plurality of images obtained by image picking-up one and the same subject on different exposure conditions are synthesized to obtain a wide dynamic range image, wherein the plurality of images are selectively made to be targets of autofocus control so that a stable focusing operation can be carried out in outputting the wide dynamic range image.

To solve the foregoing problems, the present invention provides an image pickup apparatus in which one and the same subject is image picked-up on different exposure conditions and adjacently temporally to thereby generate images corresponding to a plurality of screens different in exposure condition, and the plurality of images are synthesized to generate a synthesized image with a wide dynamic range. The image pickup apparatus according to the present invention comprises means for detecting focal voltages, which are high-frequency components contained in the plurality of screens, from the respective screens, and for storing the detected focal voltages; and focal voltage selecting means for comparing the stored focal voltages, and selectively outputting one of the focal voltages as a focal voltage to be referred to by autofocus means on the basis of a predetermined selection criterion. Then, a lens group is driven in accordance with an offset from the focal point obtained from the outputted focal voltage so that automatic focusing taken on the subject in various luminance areas can be carried out.

In addition, normalization processing is carried out on each of the focal voltages detected from the plurality of screens adjacent temporally and different in exposure condition, so as to eliminate the difference between the focal voltages caused the different exposure conditions and therefore eliminate an influence of variation in exposure condition on the focal voltages.

In addition, in the automatic focusing, the focal voltage outputted by the focal voltage selecting means at the time of starting to drive the lens group is kept on outputting for a period from starting of drive of the lens group to conclusion of reaching focusing to thereby stop moving the lens group.

In addition, when the focal voltage is to be selected, the focal voltage for focusing is selectively outputted on the basis of comparison among magnitudes of the stored focal voltages inputted to the focal voltage selecting means or on the basis of luminance level frequency distributions belonging to the screens respectively associated with the focal voltages.

In addition, the selection criterion is varied in accordance with the luminance level frequency distributions belonging to the screens respectively associated with the stored focal voltages inputted to the focal voltage selecting means. Thus, characteristics such as luminance level distribution of the subject can be taken into consideration.

In addition, the means for storing the focal voltages respectively detected from the plurality of screens extracts specific areas from the plurality of screens made to be targets for a focusing operation on the basis of information of luminance level distributions expressing features of the subject or on the basis of information of substitute areas or a synthesizing ratio at the time of synthesis, or on the basis of a combination of the information of luminance level distributions and the information of substitute areas or a synthesizing ratio. The information of luminance level distributions is obtained from a plurality of screens adjacent temporally and different in exposure condition. The information of substitute areas or a synthesizing ratio is obtained when the synthesized image is generated. Then, the means detects focal voltages from the extracted specific areas of the plurality of screens, and stores the detected focal voltages.

In addition, when there is a variation in the exposure condition associated with the focal voltage outputted from the focal voltage selecting means, an offset from a focus position is calculated again, and a series of control in a period from starting of drive of the lens group to stopping of drive of the lens group due to detection of the focal point is performed again.

In addition, predetermined-sized areas are cut out from the plurality of screens respectively. Focal voltages, which are high-frequency components contained in the cut-out areas, are detected. The detected focal voltages are stored. The stored focal voltages are compared, and one of the focal voltages is selected on the basis of the predetermined selection criterion, and outputted from the focal voltage selecting means. Thus, the lens group is stopped down when a subject is brought into focus.

### BRIEF DESCRIPTION OF THE DRAWINGS

FIG. 1 is a diagram showing examples of conventional typical images obtained when one and the same subject is picked up on different exposure conditions;

FIG. 2 is a block diagram showing the configuration of an image pickup apparatus according to an embodiment of the present invention;

FIG. 3 is a block diagram showing the internal configuration of a focal voltage normalizing portion according to an embodiment of the present invention;

FIG. 4 is a block diagram showing another form of the focal voltage normalizing portion according to a second embodiment of the image pickup apparatus according to an embodiment of the present invention;

FIG. 5 is a flow chart showing the operation of a focal voltage selecting portion according to an embodiment of the present invention;

FIG. 6 is a graph showing a selection criterion for a focal voltage rate according to an embodiment of the present invention;

FIG. 7 is a graph showing a selection criterion for a luminance level frequency according to an embodiment of the present invention;

FIG. 8 is a graph showing variations in values of selection criteria in accordance with a focal voltage rate and a luminance level frequency according to an embodiment of the present invention; and

FIG. 9 is a flow chart showing a part of the operation of the focal voltage selecting portion according to an embodiment of the present invention.

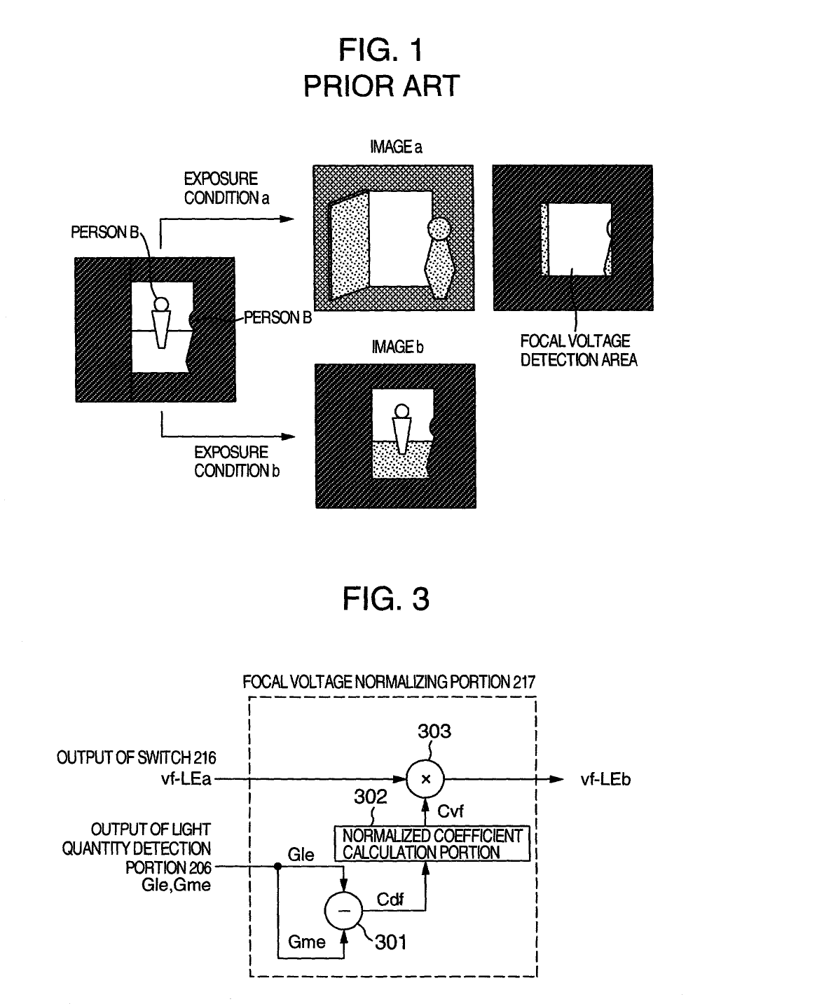

### DESCRIPTION OF THE EMBODIMENTS

A mode for carrying out the present invention will be described below with reference to the drawings.

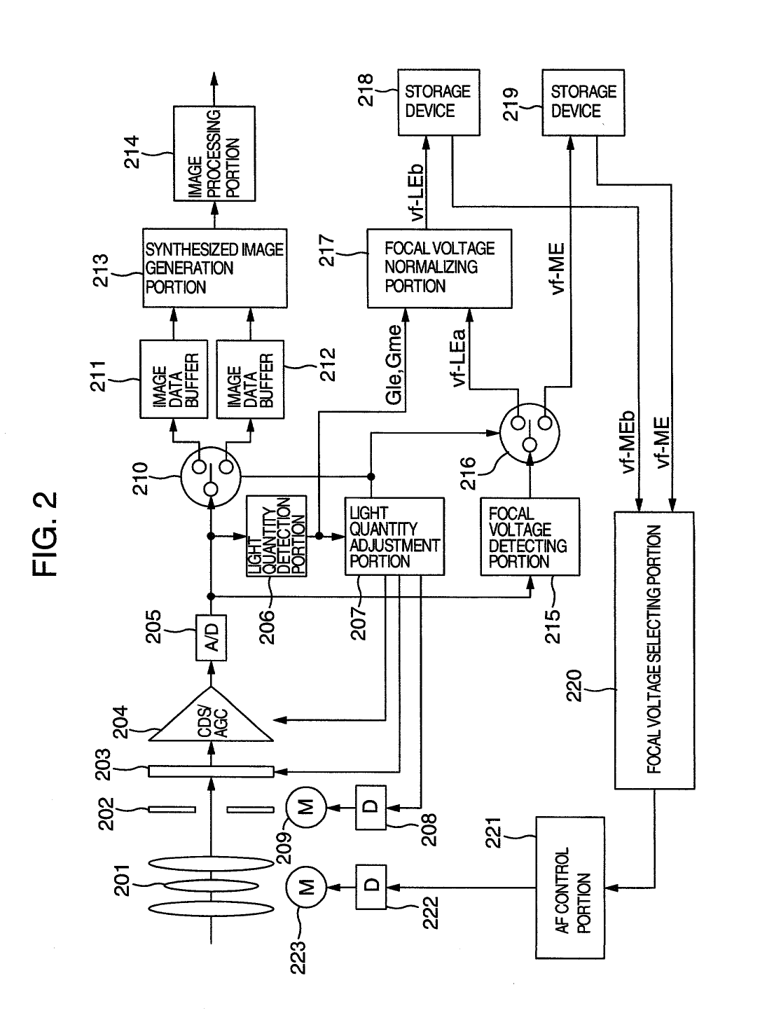

FIG. 2 is a block diagram showing the basic configuration of an image pickup apparatus having an autofocus function according to the present invention. In the image pickup apparatus, images of two screens obtained by image picking-up one and the same subject on different exposure conditions are synthesized to obtain an image with a wide dynamic range.

This image pickup apparatus has a lens group 201, an diaphragm mechanism 202, an image pickup device 203, an amplifier 204, an A/D converter 205, a light quantity detection portion 206, a light quantity adjustment portion 207, a driver 208, a diaphragm drive portion 209, a switch 210, image data buffers 211 and 212, a synthesized image generation portion 213, an image processing portion 214, a focal voltage detecting portion 215, a switch 216, a focal voltage normalizing portion 217, storage devices 218 and 219, a focal voltage selecting portion 220, an AF control portion 221, a driver 222, and a drive portion 223. The lens group 201 is constituted by a plurality of lenses including lenses movable in the optical axis direction for focusing. The diaphragm mechanism 202 limits the pass quantity of luminous flux passing through the lens group 201. The image pickup device 203 is constituted by a color CCD or the like having an electronic shutter function. The amplifier 204 amplifies a signal component in an image signal outputted from the image pickup device 203 while it eliminates a noise component in the image signal. The A/D converter 205 converts the analog image signal amplified by the amplifier 204 into a digital image. The light quantity detection portion 206 detects luminance information such as a light quantity or a luminance level frequency distribution showing the luminance level of the image digitized by the A/D converter 205. The light quantity adjustment portion 207 adjusts the aperture of the diaphragm mechanism 202, the light quantity storage time of the image pickup device 203, and the gain of the amplifier 204 to obtain images of two screens which are adjacent temporally and which are picked up on a high-gain exposure condition ME and in a low-gain exposure condition LE obtained from the detection result of the light quantity detection portion 206 by well-known means respectively. Thus, a wide dynamic range image is generated from the images of two screens obtained by image picking-up one and the same subject on different exposure conditions. The diaphragm drive portion 209 is a motor or the like for changing the aperture of the diaphragm mechanism 202. The driver 208 controls the diaphragm drive portion 209 in accordance with an instruction from the light quantity adjustment portion 207. The switch 210 switches the destination of its output in accordance with an image switching control signal from the light quantity adjustment portion 207. The image switching control signal shows whether the image from the A/D converter 205 is the image based on the exposure condition ME or the image based on the exposure condition LE. The image data buffer 211 stores image data corresponding to one of the two screens when the output of the switch 210 is associated with the exposure condition LE. The image data buffer 212 stores image data corresponding to the other of the two screens when the output of the switch 210 is associated with the exposure condition ME. The synthesized image generation portion 213 synthesizes the data stored in the image data buffer 211 and the data stored in the image data buffer 212 by well-known means so as to generate an image corresponding to one screen with a wide dynamic range. The image processing portion 214 applies various image processing such as white balance adjustment or gamma correction to the image obtained from the synthesized image generation portion 213. The focal voltage detecting portion 215 outputs a focal voltage showing the detection level of a high-frequency component contained in the image from the A/D converter 205. The switch 216 switches the output destination of the focal voltage detected by the focal voltage detecting portion 215, in accordance with the above-mentioned image switching control signal from the light quantity adjustment portion 207. When the output from the switch 216 is a focal voltage vf-LEa associated with the exposure condition LE, the focal voltage normalizing portion 217 acquires a light quantity Gme based on the exposure condition ME and a light quantity Gle based on the exposure condition LE, which are supplied from the light quantity detection portion 206. Then, the focal voltage normalizing portion 217 multiplies the focal voltage vf-LEa by a normalized coefficient obtained from the light quantities Gle and Gme. The storage device 218 stores a focal voltage vf-LEb which has been normalized by the focal voltage normalizing portion 217. When the output from the switch 216 is a focal voltage vf-ME associated with the exposure condition ME, the storage device 219 stores the focal voltage vf-ME. The focal voltage selecting portion 220 compares the data stored in the storage device 218 with the data stored in the storage device 219, and selects a focal voltage for use in AF (autofocus) control. The AF control portion 221 calculates the moving distance of the lens group 201 in accordance with a focal offset obtained from the focal voltage outputted by the focal voltage selecting portion 220. The drive portion 223 is constituted by a motor or the like for moving the lens group 201 in the optical axis direction. The driver 222 controls the drive portion 223 in accordance with an instruction from the AF control portion 221.

FIG. 3 is a block diagram showing the processing configuration of the focal voltage normalizing portion 217 according to an embodiment of the present invention. In the focal voltage normalizing portion 217, the focal voltage vf-LEa is normalized to eliminate a difference between the focal voltages vf-ME and vf-LEa caused by a difference Gdf between the light quantity Gme [dB] on the exposure condition ME and the light quantity Gle [dB] on the exposure condition LE. An operational expression for the normalization is shown in Expression 1.

$$vf \text{-} LEb = {10}^{( \frac{Gme \text{-} Gle}{20} )} \cdot vf \text{-} LEa \qquad Expression 1$$

Next, the operation of the focal voltage normalizing portion 217 will be described with reference to FIG. 3. The focal voltage normalizing portion 217 receives the light quantity Gle detected on the exposure condition LE and the light quantity Gme detected on the exposure condition ME, while the light quantities Gle and Gme are outputted from the light quantity detection portion 206. Then, in a subtracter 301, an operation shown in Expression 2 is performed to calculate the light quantity difference Gdf. Next, in a normalized coefficient calculation portion 302, the light quantity difference Gdf which is a decibel value is converted into a magnification value in accordance with Expression 3. Thus, a normalized coefficient Cvf for normalizing the focal voltage vf-Lea is obtained. Then, in a multiplier 303, the focal voltage vf-LEa which is the output of the switch 216 is multiplied by the normalized coefficient Cvf obtained from the normalized coefficient calculation portion 302. Thus, a focal voltage vf-LEa is normalized to obtain a focal voltage vf-LEb from which the difference between the focal voltage vf-LEa and the focal voltage vf-ME due to the difference in exposure condition has been eliminated. The focal voltage vf-LEb is set as the output of the focal voltage normalizing portion 217.

Gdf=Gme−Gle Expression 2

$$Cvf = {10}^{\frac{Gdf}{20}} \qquad Expression 3$$

Thus, by normalizing the focal voltage vf-LEa, the focal voltage selecting portion 220 disposed in a post-stage can obtain a stable processing result independently of the variation in exposure condition.

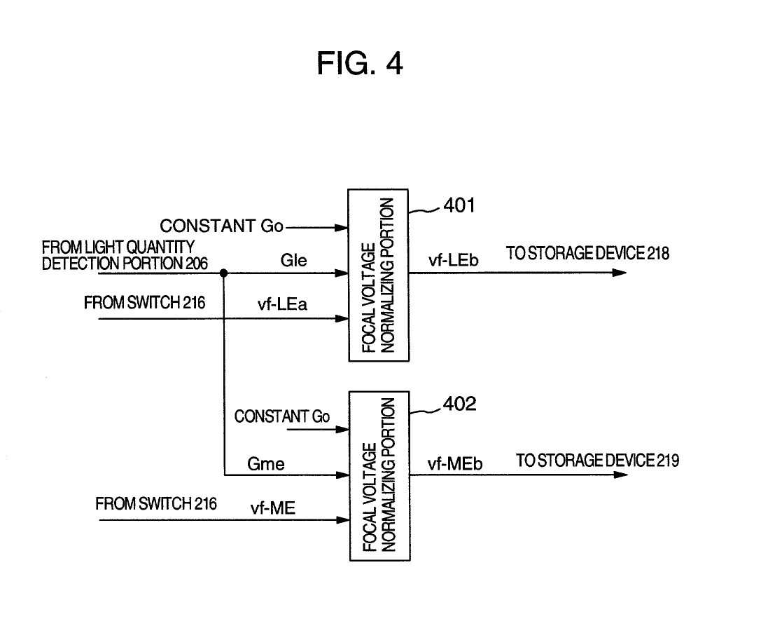

Further, normalization processing is applied only to the focal voltage vf-LEa associated with the exposure condition LE in the embodiment of FIG. 2. However, as shown in FIG. 4 which is a block diagram showing a focal voltage normalizing portion of the image pickup apparatus according to a second embodiment of the present invention, focal voltage normalizing portions 401 and 402 may be provided to normalize, respectively, the focal voltages vf-LEa and vf-ME supplied from the switch 216. In the configuration of FIG. 4, the focal voltage normalizing portion 401 acquires from the light quantity detection portion 206 the light quantity Gle based on the exposure condition LE. Then, the focal voltage normalizing portion 401 applies an operation shown in Expression 4 to the focal voltage vf-LEa from the switch 216 in the same processing as that in the above-mentioned focal voltage normalizing portion 217. “Go” in Expression 4 designates a desired value determined in advance, showing a reference of normalization. On the other hand, the focal voltage normalizing portion 402 acquires from the light quantity detection portion 206 the light quantity Gme based on the exposure condition ME. Then, the focal voltage normalizing portion 402 applies an operation shown in Expression 5 to the focal voltage vf-ME from the switch 216 in the same manner as that described in the focal voltage normalizing portion

$$\begin{matrix}vf \text{-} LEb = {10}^{( \frac{Go \text{-} Gle}{20} )} \cdot vf \text{-} LEa & Expression 4 \\ vf \text{-} MEb = {10}^{( \frac{Go \text{-} Gme}{20} )} \cdot vf \text{-} ME & Expression 5\end{matrix}$$

Thus, the focal voltages vf-MEb and vf-LEb normalized with the reference Go are always calculated. Thus, a stable focal voltage can be obtained independently of the exposure conditions, and further, a stable operation can be obtained in the focal voltage selecting portion 220 and the AF control portion 221 disposed in a post-stage.

Of course, the normalization operations carried out in the focal voltage normalizing portions 401 and 402 are not limited to Expressions 4 and 5. For example, a focal voltage vf-LEap associated with the exposure condition LE and a focal voltage vf-MEp associated with the exposure condition ME may be normalized in accordance with operations shown in Expression 6, as references for normalization while the focal voltage vf-LEap and the focal voltage vf-MEp are supplied from the switch 216 in a previous exposure cycle.

$$\begin{matrix}vf \text{-} LEb = ( \frac{vf \text{-} LEa - vf \text{-} LEap}{vf \text{-} LEap} ) \\ vf \text{-} MEb = ( \frac{vf \text{-} ME - vf \text{-} MEp}{vf \text{-} MEp} )\end{matrix} \} \qquad Expression 6$$

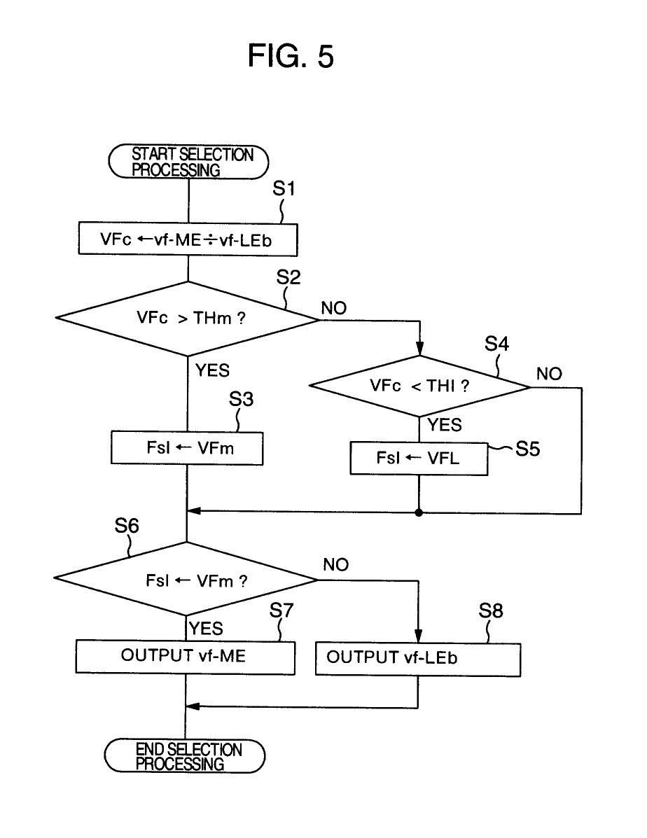

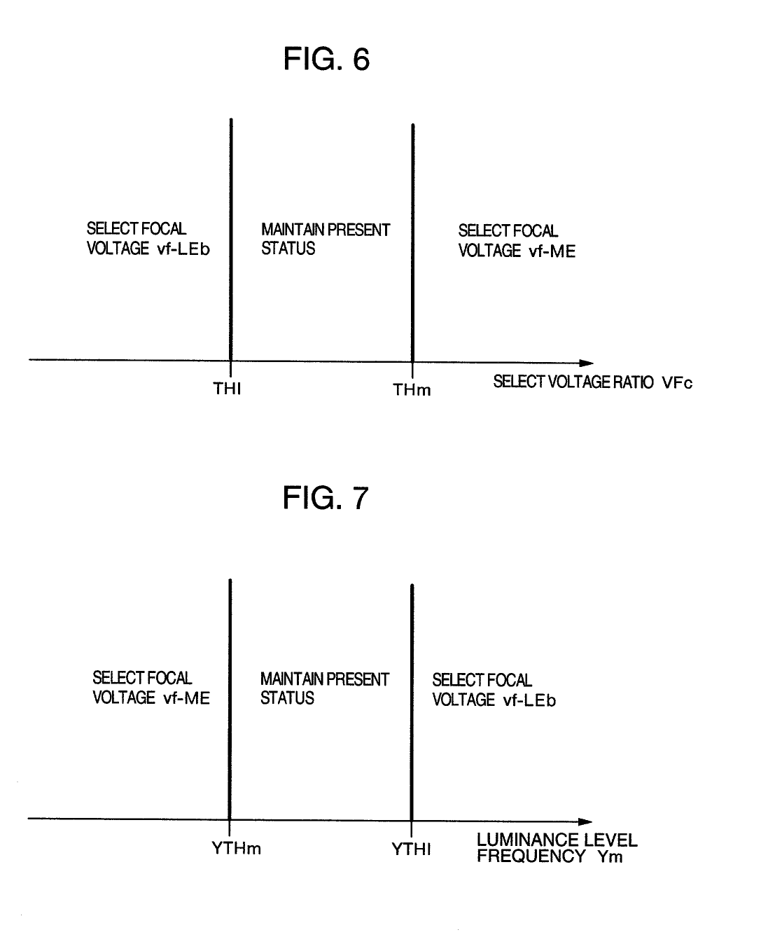

Next, the operation of the focal voltage selecting portion 220 will be described. The operation of the focal voltage selecting portion 220 is shown in the flow chart of FIG. 5. In addition, FIG. 6 is a graph showing a selection criterion for a focal voltage according to an embodiment of the present invention. The focal voltage selecting portion 220 starts selection processing of a focal voltage in synchronism with a pickup cycle on the exposure conditions ME and LE.

When the focal voltage selection processing is started, the focal voltages vf-ME and vf-LEb stored in the storage devices 218 and 219 are acquired, and the focal voltage vf-ME is divided by the focal voltage vf-LEb so as to calculate a ratio VFc (Step S1). The ratio VFc is compared with a predetermined selection reference value THm. If the ratio VFc is larger than the selection reference value THm, a value VFm indicating that the focal voltage vf-ME is selected is set in a binary flag Fsl which indicates a selected focal voltage (Steps S2 and S3). If the ratio VFc is not larger than the selection reference value THm, the ratio VFc is compared with a predetermined selection reference value THl. If the ratio VFc is smaller than the selection reference value THl, a value VFl indicating that the focal voltage vf-LE is selected is set in the binary flag Fs1. If the ratio VFc is not smaller than the selection reference value THl (THl≦VFc ≦THm), the flag Fsl is not updated and the previously selected result is maintained (Steps S4 and S5). Next, with reference to the flag Fsl, the focal voltage vf-ME is outputted if the value of the flag Fsl is VFm. If the flag Fsl takes a value other than vf-ME, the focal voltage vf-LEb is outputted (Steps S6, S7 and S8). Then, the operation is terminated.

In addition, in the operation of FIG. 5, the ratio of the focal voltage vf-ME to the focal voltage vf-LEb is set to VFc. However, the result of subtraction of the focal voltage vf-LEb from the focal voltage vf-ME may be set to VFc.

Thus, a larger focal voltage is selected from the focal voltages vf-LEb and vf-ME respectively associated with the exposure conditions LE and ME, and the selected focal voltage is supplied to the AF control portion 221. As a result, a focal point which could not be detected only from a focal point associated with one of the exposure conditions LE and ME can be detected so that a stable focusing operation can be obtained independently of the luminance distribution of the subject.

In addition, a luminance level frequency distribution of an image associated with the exposure condition ME may be acquired from the light quantity detection portion 206. In this case, a luminance level frequency Ym not lower than a desired luminance level Y determined in advance is detected. The luminance level frequency Ym is compared with predetermined selection reference values YTHl and YTHm (YTHl>YTHm), and a focal voltage may be selected in accordance with the graph of FIG. 7 which shows a selection criterion for the luminance level frequency Ym. Thus, a focal voltage is selected in accordance with the luminance level frequency distribution in the image associated with the exposure condition ME so that a subject in areas having a dominant luminance level can be selectively brought into focus.

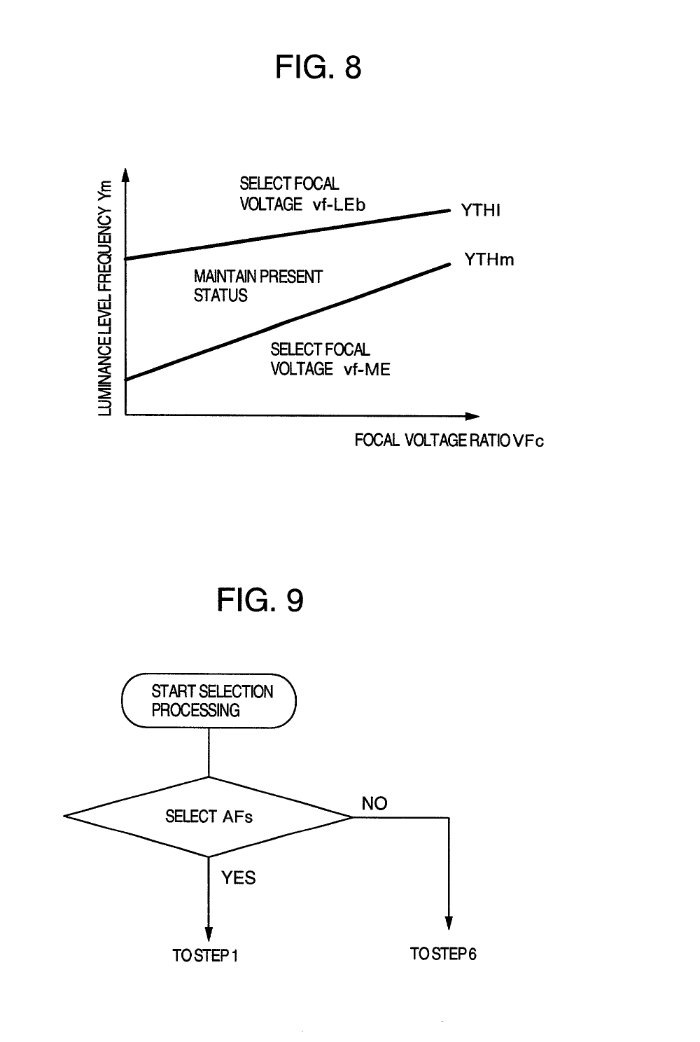

Further, processing for calculating the luminance level frequency Ym, and processing for dynamically varying the selection reference values YTHm and YTHl, for example, in accordance with the characteristic shown in FIG. 8 which is a graph showing variations of the selection reference values in accordance with the focal voltage ratio VFc and the luminance level frequency Ym, may be added to the above-mentioned processing of FIG. 5. If the selection reference values YTHm and YTHl are varied in accordance with the characteristic of FIG. 8, a subject located in a low-luminance area becomes easily brought into focus when the focal voltage vf-ME of an image associated with the exposure condition ME exhibits a larger value even if a high-luminance area is dominant. On the contrary, a subject located in the high-luminance area becomes easily brought into focus when the focal voltage vf-LEb of an image associated with the exposure condition LE exhibits a larger value even if the low-luminance area is dominant. Thus, it is possible to obtain a focusing operation having a characteristic taking not only the luminance distribution but also the existence of the subject into consideration.

Of course, the selection reference values YTHl and YTHm shown in FIG. 8 may vary in curves.

In addition, in order to stop down the lens group for a focused place or a subject, predetermined-sized areas may be cut out from a plurality of screens different in exposure condition respectively, focal voltages which are high-frequency components contained in the cut-out areas respectively may be detected, and the detected areas of the focal voltages may be limited.

In addition, in the configuration of FIG. 2, while a signal AFs indicating that a focal point has been detected in the AF control portion 221 is supplied from the AF control portion 221 to the focal voltage selecting portion 220, an operation shown in the flow chart of FIG. 9 showing a part of the operation of the focal voltage selecting portion may be added to the above-mentioned operation of the focal voltage selecting portion 220. In this case, the focal voltage selecting portion 220 does not detect the signal AFs in the period from the detection of an offset from a focal point by the AF control portion 221 to the detection of the focal point by the AF control portion 221. Therefore, the focal voltage selecting portion 220 always keeps on outputting a focal voltage associated with the same exposure condition in such a period.

Further, in the configuration of FIG. 2, a signal VFch indicating that a focal voltage on an exposure condition different from that for a previous focal voltage has been selected in the focal voltage selecting portion 220 may be supplied from the focal voltage selecting portion 220 to the AF control portion 221. Then, when the signal VFch is detected in the AF control portion 221, an offset from a focal point is calculated again, and focus control is restarted. Thus, in such a manner that the focal voltage selecting portion 220 and the AF control portion 221 are synchronized with each other, it is possible to carry out a more stable focusing operation.

According to the present invention, there is obtained an effect that, in an image pickup apparatus in which a plurality of images of one and the same subject picked up on different exposure conditions are synthesized to obtain a wide dynamic range image, the plurality of images are selectively made to be targets of autofocus control so that a stable focusing operation can be always carried out while the wide dynamic range image is outputted.

In addition, focal voltages obtained from the plurality of images are normalized so that a stable focusing operation can be carried out independently of exposure conditions.

In addition, the images made to be the targets for autofocus control are selected in accordance with luminance distribution states of picked-up images and focal voltages detected from the plurality of images. Thus, autofocus control to which the luminance distribution state of the screen and the optimum of the targets to be brought into focus are added are performed. Accordingly, a focusing operation intended by a user can be obtained.

What is claimed is:

1. An image pickup apparatus comprising:
lens group drive means for driving a lens group to thereby adjust every focal point of said lens group;
image pickup means for image picking-up one and the same subject to generate a plurality of screens adjacent temporally and different in exposure condition, said plurality of screens being synthesized to form a synthesized image;
means for detecting focal voltages from said plurality of screens and storing said detected focal voltages, said focal voltages containing high-frequency components included in said plurality of screens; and
focal voltage selecting means for selectively outputting one of said stored focal voltages on the basis of a predetermined selection criterion;
wherein automatic focusing is carried out in accordance with said focal voltage outputted from said focal voltage selecting means.

2. An image pickup apparatus according to claim 1, wherein normalization processing is carried out on each of said focal voltages detected from said plurality of screens adjacent temporally and different in exposure condition so that an influence of variation in said exposure condition on said focal voltages is eliminated.

3. An image pickup apparatus according to claim 1, wherein in said automatic focusing, said focal voltage selecting means keeps on outputting said focal voltage outputted at the time of starting to drive said lens group in a period from starting of drive-of said lens group to conclusion of reaching focus to thereby stop moving said lens group.

4. An image pickup apparatus according to claim 1, wherein said focal voltage selecting means selectively outputs a focal voltage for focusing in accordance with magnitudes of said stored focal voltages inputted to said focal voltage selecting means.

5. An image pickup apparatus according to claim 1, wherein said focal voltage selecting means selectively outputs a focal voltage for focusing on the basis of comparison among luminance level frequency distributions belonging to said screens respectively associated with said stored focal voltages inputted to said focal voltage selecting means.

6. An image pickup apparatus according to claim 1, wherein said focal voltage selecting means varies said selection criterion in accordance with luminance level frequency distributions belonging to said screens respectively associated with said stored focal voltages inputted to said focal voltage selecting means.

7. An image pickup apparatus according to claim 1, wherein:
said means for storing said focal voltages detected from said plurality of screens extracts specific areas from said plurality of screens to be focused, on the basis of information of luminance level distributions expressing characteristics of said subject, or on the basis of information of substitute areas or a synthesizing ratio in synthesis, or on the basis of a combination of said information of luminance level distributions and said information of substitute areas or a synthesizing ratio, said information of luminance level distributions being obtained from said plurality of screens adjacent temporally and different in exposure condition, said information of substitute areas or a synthesizing ratio being obtained when said synthesized image is generated; said means detects focal voltages from said extracted specific areas of said plurality of screens; and said means stores said detected focal voltages.

8. An image pickup apparatus according to claim 1, wherein when said exposure condition associated with said focal voltage outputted from said focal voltage selecting means varies, an offset from the focal point is calculated again, and a series of control in a period from starting of drive of said lens group to stopping of the drive when a focused point is detected is performed again.

9. An image pickup apparatus comprising:
lens group drive means for driving a lens group to thereby adjust every focal point of said lens group;
image pickup means for image picking-up one and the same subject to generate a plurality of screens adjacent temporally and different in exposure condition, said plurality of screens being synthesized to generate a synthesized image;
means for cutting out predetermined-sized areas from said plurality of screens respectively;
means for detecting focal voltages, which are high-frequency components contained in said areas cut out from said plurality of screens, and for storing said detected focal voltages; and
focal voltage selecting means for comparing said stored focal voltages, and selectively outputting one of said focal voltages on the basis of a predetermined selection criterion;
wherein automatic focusing is carried out in accordance with said focal voltage outputted from said focal voltage selecting means.

10. An image pickup apparatus according to claim 9, wherein normalization processing is carried out on each of said focal voltages detected from said areas cut out from said plurality of screens adjacent temporally and different in exposure condition so that an influence of variation in said exposure condition or said cut-out area on said focal voltages is eliminated.

11. An image pickup apparatus according to claim 9, wherein in said automatic focusing, said focal voltage selecting means keeps on outputting said focal voltage outputted at the time of starting to drive said lens group in a period from starting of drive of said lens group to conclusion of reaching focus to thereby stop moving said lens group.

12. An image pickup apparatus according to claim 9, wherein said focal voltage selecting means selectively outputs a focal voltage for focusing in accordance with magnitudes of said stored focal voltages inputted to said focal voltage selecting means.

13. An image pickup apparatus according to claim 9, wherein said focal voltage selecting means selectively outputs a focal voltage for focusing on the basis of comparison among luminance level frequency distributions belonging to said areas cut out from said screens respectively associated with said stored focal voltages inputted to said focal voltage selecting means.

14. An image pickup apparatus according to claim 9, wherein said focal voltage selecting means varies said selection criterion in accordance with luminance level frequency distributions belonging to said areas cut out from said screens respectively associated with said stored focal voltages inputted to said focal voltage selecting means.

15. An image pickup apparatus according to claim 9, wherein when said exposure condition or said cut-out area associated with said focal voltage outputted from said focal voltage selecting means varies, an offset from the focal point is calculated again, and a series of control in a period from starting of drive of said lens group to stopping of the drive when a focused point is detected is performed again.
